(19) United States
(12) Patent Application Publication
(10) Pub. No.: US 2013/0080521 A1
(43) Pub. Date: Mar. 28, 2013

(54) RESOLVING CONTACTS IN CONFLICT THROUGH SUGGESTION

(71) Applicants: Jeremy de Souza, Seattle, WA (US); Mayerber Carvalho Neto, Kirkland, WA (US); Komal Kashiramka, Redmond, WA (US); Ladislau Conceicao, Redmond, WA (US)

(72) Inventors: Jeremy de Souza, Seattle, WA (US); Mayerber Carvalho Neto, Kirkland, WA (US); Komal Kashiramka, Redmond, WA (US); Ladislau Conceicao, Redmond, WA (US)

(73) Assignee: Microsoft Corporation, Redmond, WA (US)

(21) Appl. No.: 13/246,864

(22) Filed: Sep. 28, 2011

(51) Int. Cl. G06F 15/16

(52) U.S. Cl. 709/204

(57) ABSTRACT

A communication application resolves contacts in conflict through a suggestive user interface. The communication application retrieves a contact that includes conflicting information with an existing contact from an external resource through a data service. External resources include social networks, e-mail servers, local address providers, etc. The user application employs a sliding scale algorithm to recognize the contact that includes the conflicting information according to a variety of categories including source of the contact, level of interaction and number of matching identifiers between the user and the contact. Subsequently, the communication application presents a suggestion to link the contact that includes the conflicting information with the existing contact to the user in a linking user interface. Upon a user acceptance of the suggestion, the communication application links the contact that includes the conflicting information to the existing contact.

### BACKGROUND

Contemporary communication systems enable users to have a number of identities over various systems such as enterprise emails, personal emails, social networking exchanges, and comparable ones. Each of these systems may generate contact lists based on automatic processing of exchange information and/or manual input. A structure and content of contact information for distinct communication systems may be different depending on their infrastructure. Thus, a user may have a plurality of contact information for the same contact stored in each communication system they are associated with.

Increasingly, other applications are becoming capable of providing access to multiple communication systems for a user. For example, an electronic mail exchange application may be configured to send and receive emails from a variety of systems for a user managing the user's identities automatically. Because each communication system tends to have its own contact lists, it is a challenge for users to manage multiple contacts while using multiple communication clients. Conflicts arise when a user attempts to communicate with a contact while accessing the contact information from multiple sources. Manual contact conflict resolution costs to the user and ultimately to an organization in the time and effort invested in resolving contact conflicts and synchronizing contacts across multiple sources.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to resolving contacts in conflict through suggested links. A communication application may retrieve a contact in conflict with an existing contact from a data service. Subsequently, the application may present a suggestion to link the contact that includes conflicting information with the existing contact. The application, through a linking user interface, may prompt for action based on the suggestion. Upon detecting a user acceptance of the suggestion, the application may link the contact that includes the conflicting information with the existing contact creating a linked contact. Upon detecting a user rejection of the suggestion, the application may discard the contact that includes the conflicting information.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF DRAWINGS

FIG. 1 is a conceptual diagram illustrating high level entities in a system for resolving contacts in conflict;

FIG. 2 is another conceptual diagram illustrating a basic example of a system for resolving contact conflicts;

FIG. 3 illustrates major components of an application resolving conflicting contact information according to embodiments;

FIG. 4 illustrates an example user interface displaying contacts that include conflicting information in a system according to embodiments;

FIG. 5 illustrates another example user interface displaying suggestions to link the contacts in conflict;

FIG. 6 illustrates an example user interface displaying additional functionality to increase user confidence in the resolution process;

FIG. 7 is a networked environment, where a system according to embodiments may be implemented;

FIG. 8 is a block diagram of an example computing operating environment, where embodiments may be implemented; and

FIG. 9 illustrates a logic flow diagram for a process of resolving contact conflicts through suggested links according to embodiments.

### DETAILED DESCRIPTION

As briefly described above, contacts that include conflicting information may be resolved with a suggested link by a communication application. The application may retrieve a contact in conflict with an existing contact from a data service. A conflict may arise from duplicate, contradictory, and other inconsistent contact retrieved from an external source such as a social network or a publicly available directory. The application may determine a suggestion to link the contact that includes conflicting information to the existing contact. The suggestion may be a user selection to link the contact that includes the conflicting information to the existing contact. The application may display the suggestion to the user through a linking user interface and await a response. The application may link the two contacts upon an acceptance. The application may discard the contact that includes the conflicting information upon a rejection.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in the limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

According to embodiments, a contact may be information needed to communicate with another user. Contact may include the user's name, e-mail address(es), telephone number(s), user-id(s), address(es), etc. Contact may also include dynamic information such as a user's presence information including availability and location. Contacts may be retrieved from external sources to supplement existing contacts. A retrieved contact may be in conflict with an existing contact due to variety of reasons. A retrieved contact may have the same identifier information such as a user's whole name or partial name, same user id, and same e-mail address as an existing contact. The contact that includes conflicting information may contain identifier information not found in the existing contact. In an example scenario a contact that includes conflicting information with the same name as an existing contact may have an e-mail address not found in the existing contact.

Throughout this specification, the term “server” generally refers to a computing device executing one or more software programs typically in a networked environment. However, a server may also be implemented as a virtual server (software programs) executed on one or more computing devices viewed as a server on the network. Similarly, a “client” may refer to a computing device enabling access to a communication system or an application executed on a computing device enabling a user to access a networked system such as a social networking service, an e-mail exchange service, and comparable ones. More detail on these technologies and example operations is provided below.

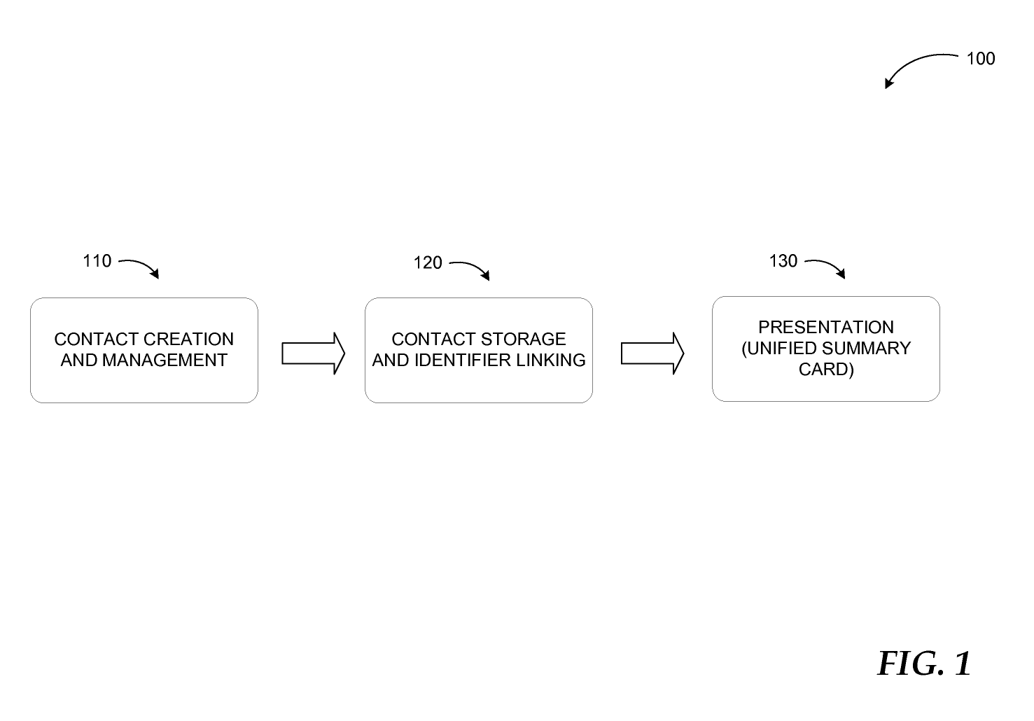

Referring to FIG. 1, diagram 100 illustrates high level entities in a system for resolving contacts in conflict. A communication application according to embodiments may create and manage contacts 110. The application may automate contact management. An example may be the application automatically aggregating contacts retrieved from variety of sources. Alternatively, the application may enable an administrator to manually manage contacts through workflow alterations.

According to embodiments, the application may store contacts and link contacts according to user identifiers 120. The application may link multiple contacts according to identifier attributes such as common names, e-mail addresses, user-ids, etc. The linked contact may provide a single contact representing a logical user. The application may also identify redundant contacts and handle redundancies according to application policy.

Additionally, the application may present the linked contact as a unified summary card 130. The unified summary card represents the logical user. The summary card may present a unified view of all identifier information in the linked contact. The application may display the summary card to represent the user as a single contact entity. Additionally, an external application with access to the communication application may retrieve the summary card to present the user as a single contact entity.

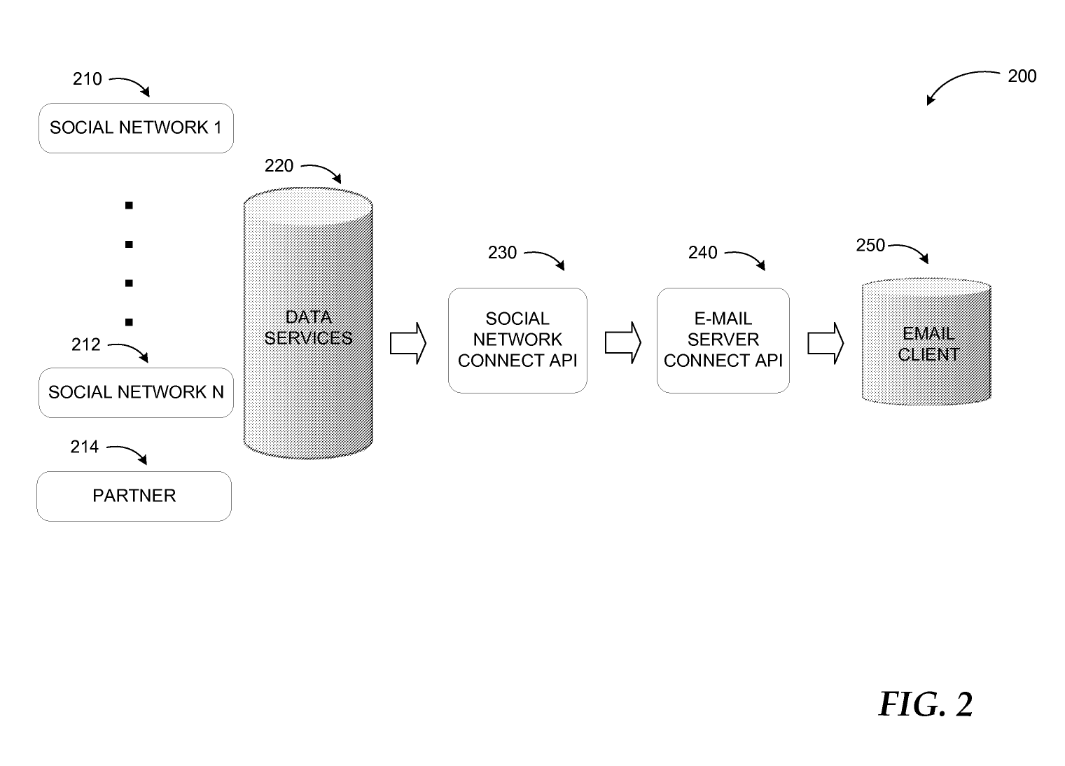

FIG. 2 is another conceptual diagram illustrating a basic example of a system for resolving contact conflicts. While a system according to embodiments is likely to include a number of applications, application programming interfaces (APIs), and services such as those illustratively discussed in FIG. 1, only those relevant to embodiments are shown in FIG. 2.

A communication application such as an e-mail client 250 illustrated in diagram 200 may utilize a number of APIs to retrieve contacts from a number of sources. Sources such as social network 1 (210) through social network N (212) may provide contacts to the communication application through data services 220. Additionally, partner applications 214 may also provide contacts to the application through data services 220. Additional sources may include publicly available address books or directories directly from a data provider or indirectly through search engines.

A social network connect API 230 may interface with the data services provided by contact sources and provide a single point of access to retrieve the provided contacts. The social network connect API 230 may be tailored to work with an e-mail server connect API 240 to store the retrieved contacts in an e-mail server. The stored contacts may be accessed and managed by the e-mail client 250. The e-mail client 250 may be an e-mail application executing on a variety of platforms and devices including desktop and mobile devices.

While the example system in diagram 200 is shown using an email service as basis, embodiments may be implemented in any application that facilitates real time or asynchronous communications such as Voice over Internet Protocol (VOIP) telephony, text messaging, video conferencing, application sharing, and comparable ones using the principles described herein.

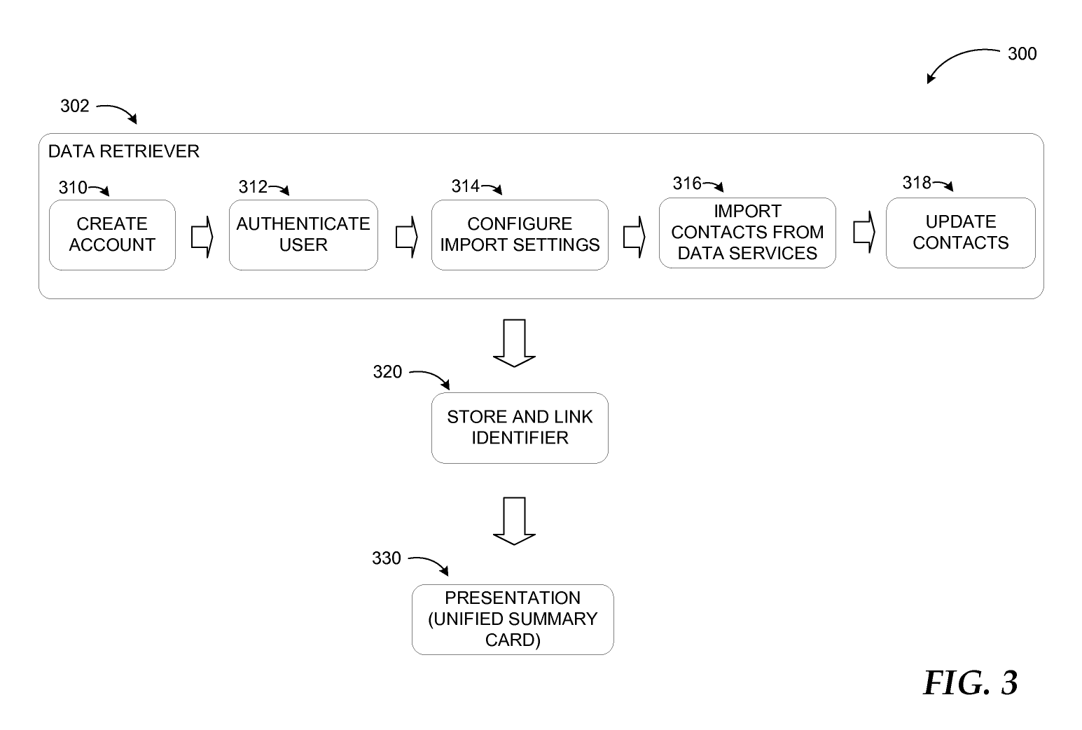

FIG. 3 illustrates major components of an application resolving conflicting contact information according to embodiments. Diagram 300 displays major components of the communication application. The data retriever component 302 may provide functionality to retrieve and manage contacts from a variety of sources.

The data retriever component 302 may have a create account sub-component 310 for managing new users. Existing users may access the application through authenticate user component 312. Authentication methods may include user-id/password combinations, encryption, biometric tools, etc. The application may utilize configure import settings component 314 upon authenticating the user. In an example scenario, the configure import settings component 314 may identify external sources to retrieve contacts for the authenticated user.

Next, the application may import contacts from data services 316. The application may utilize connect APIs described above to access the data services. The connect APIs may enable access to data services of external contact sources through server applications such as an e-mail server application. Upon retrieving the contacts, the application may update existing contacts 318. New contacts may be stored. Contacts that include conflicting information may be stored and linked (320) to the existing contact. Updated contacts may be presented to the user in a unified summary card 330 component of the linking user interface.

The above discussed scenarios, example communication application, contact information, or systems in FIG. 1-3 are for illustration purposes. Embodiments are not restricted to those examples. Other forms of contact conflict resolution may be used in implementing the linking user interface in a similar manner using the principles described herein.

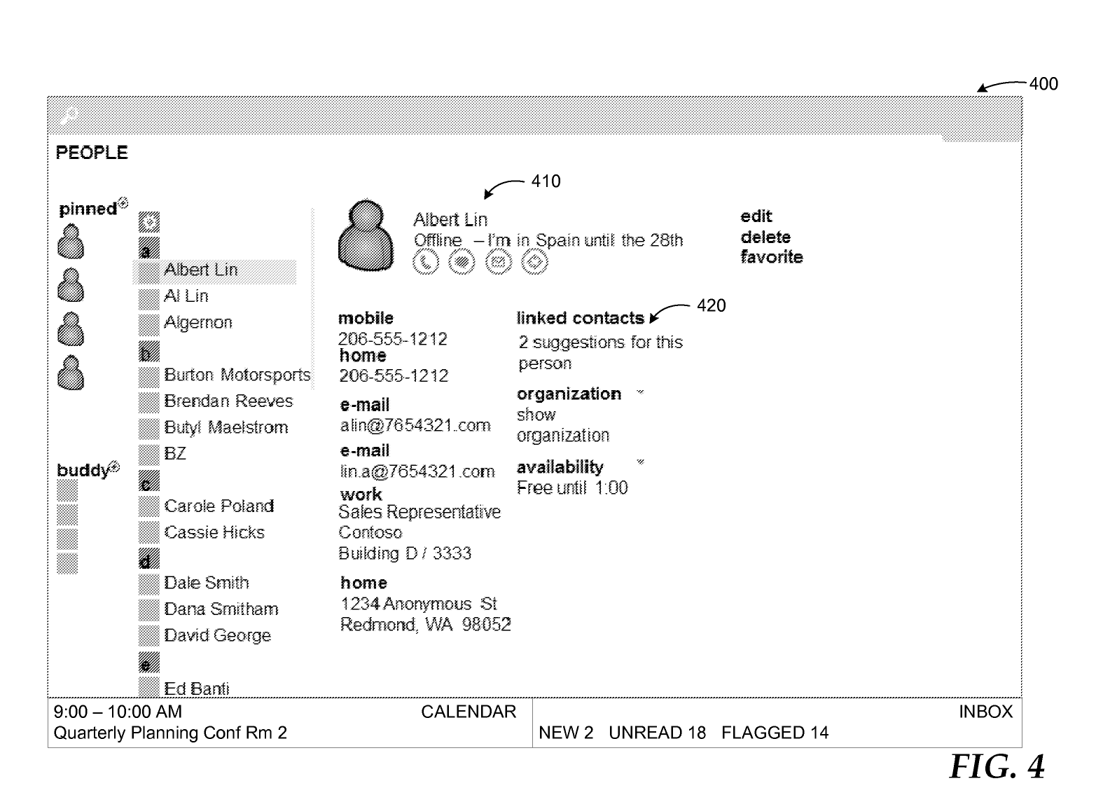

FIG. 4 illustrates an example user interface displaying contacts that include conflicting information in a system according to embodiments. Diagram 400 illustrates a communications application user interface showing contact 410. The application presents the user's contacts and the contacts' information. The contact information for contact 410 includes the contact's identifier information such as name, phone numbers, e-mail addresses, addresses, etc. Additionally, the contact information includes presence information such as contact's location and availability.

The application may also present a linking user interface to resolve conflicting contact information. The linking user interface may indicate suggestions 420 to link contacts that include the conflicting information. The application may retrieve contacts from external sources such as social networks, e-mail servers, etc. The application may determine contacts matching an existing contact such as contact 410 through similar identifier information such as matching names, e-mail addresses, user-id(s), etc. Upon determining matching contacts, the application may suggest linking the retrieved contacts to the existing contact to resolve the conflict. According to some embodiments, the visualization of individual fields of the aggregated view of linked contacts may indicate which sources they have the same value (e.g., the field “First Name” shows “John” and next to it a visual element can show that name can come from user's private address book and from corporate directory, or social network).

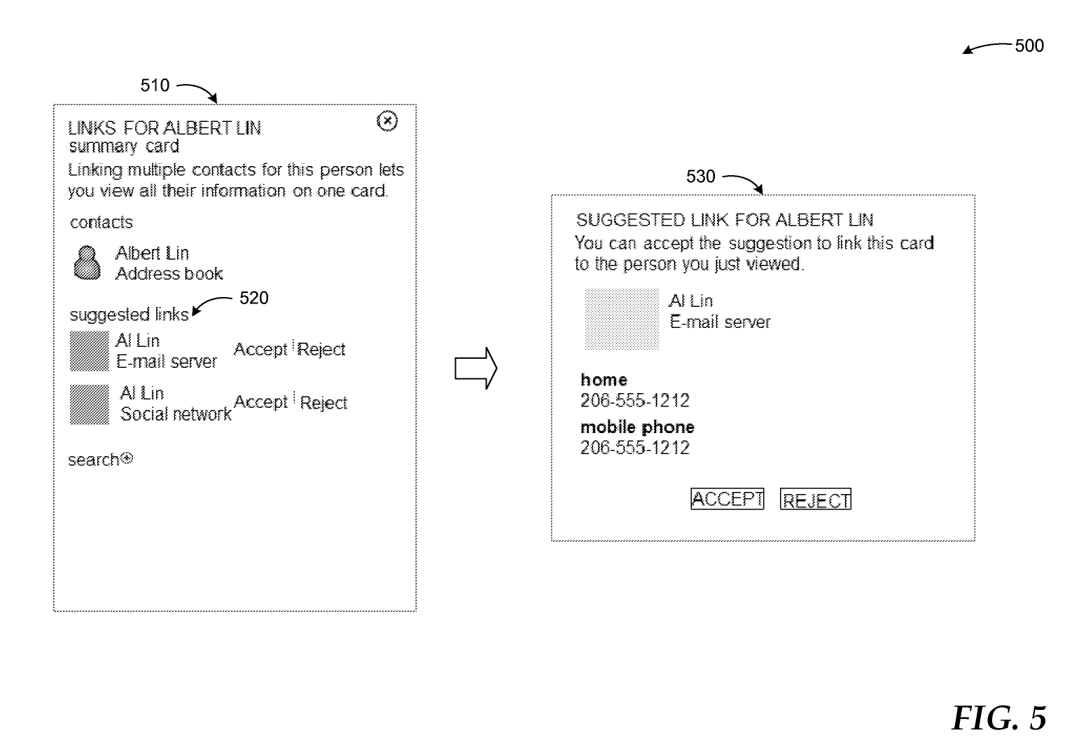

FIG. 5 illustrates another example user interface displaying suggestions to link the contacts in conflict. Diagram 500 displays a linking user interface 510. The linking user interface may be a unified summary card displaying suggested links 520 for resolving the conflicting contact information as described above. Suggested links 520 include a picture/icon along with the name of the contact and a source of the contact information. In other embodiments, additional information such as the conflicting information details may also be presented. A user selection to view a suggestion may prompt the communication application to display another summary card 530 illustrating information about the existing contact and the contact that includes conflicting information to be linked to the existing contact. Displaying additional information about the contacts to be linked may empower the user to make an informed decision about linking the contact that includes conflicting information.

According to an embodiment, the linking user interface may enable aggregate presentation of contacts regardless of source (e.g.: social network, e-mail server, organizational address book, etc.). Suggested links may enable the user to quickly review conflicts and resolve them. In addition to suggested links, the user may also be enabled to manually search and browse to find a contact and link with an existing contact.

According to another embodiment, the linking user interface may provide a unified navigation model for resolving contact conflicts. A user may resolve a conflict through a summary card. The user may be presented with a summary card to resolve conflicting contact information through suggestions. The user may be presented with another summary card at the resolution of a conflict. The communication application may implement link counts, contact with an appearing-disappearing manner, and animated contact to inform the user of the contact that includes conflicting information during the conflicting information resolution. Upon completion of the resolution, revert the summary card with the suggestion discarded.

Additionally, a linking user interface may scale to multiple platforms. The communication application may adjust the linking user interface by displaying a suggestion in a scalable summary card to resolve conflicting contact information in mobile device based as well as desktop device based platforms. As a result, the user may perform uniform conflict resolution tasks across varying platforms to resolve conflicting contact information in a similar manner. In an example scenario, the user may initiate a substantially similar linking interface in a notebook or tablet application while browsing contacts, searching contacts, interacting with e-mail, etc.

In an embodiment, the communication application may utilize a suggestion model algorithm to detect contacts in conflict with existing contacts. The algorithm may implement a sliding scale for matching confidence according to similar contact identifier information such as name, e-mail address, phone number, instant messaging (IM) address, birthdate, and other biographical data. The algorithm may scale based on amount of identifier information between the contact that includes conflicting information and the existing contact. A complete match including all the identifier information between the contacts may assign a high confidence score on the sliding scale analysis compared to a partial match. The algorithm may also score a match between the contacts higher or lower according to source of contact that includes conflicting information. A local source of information such as an organization e-mail server may increase a confidence score compared to decrease of the confidence score for an external source such as a social network. Additionally, the suggestion algorithm may assess the relevance of the identifier information according to communication patterns. In an example scenario, the suggestion algorithm may determine whether the existing contact reaches a predetermined level of interaction (e.g.: number of e-mails from the existing contact) with the user to effect conflict resolution with a contact that includes conflicting information. A high level of interaction may determine a high confidence score for a contact that includes conflicting information. A low level of interaction may determine a low confidence score for a contact that includes conflicting information.

According to another embodiment, the communication application may guide a user during conflicting contact information resolution through suggestions. The application may weigh confidence in the contact that includes conflicting information according to criteria. Criteria may include organizational and personal type relationships.

According to yet another embodiment, the application's linking user interface may also display limited number of suggestions. The limited number of suggestions may be a predetermined number of suggestions according to application settings to streamline resolving the conflicting contact information. The linking user interface may also show additional detail about the suggestion and the contact that includes the conflicting information through actionable components. In an example scenario, selection of an actionable component may prompt a summary card to display conflicting contact information during the suggestion process. Additionally, the linking user interface may display the suggestion in-line with other suggestions to streamline user action in resolving conflicting contact information.

In another embodiment, the linking user interface may provide hints to remind a user about available suggested links during a variety of application workflows. In a few non-exclusive example scenarios, the communication application may prompt hints to link contacts that include conflicting information through the linking user interface while a user is receiving a communication from the contact that includes the conflicting information, the user performing a search, and the user editing and saving contact information for the contact that includes the conflicting information. Edit operation of aggregated view of linked contacts may include ability for the user to select which particular contact to edit the information. For example, if the user has two contacts in a private address book that are linked together with each having the e-mail address in the field “E-mail Address”, the user might choose to change that value only in the first contact to update.

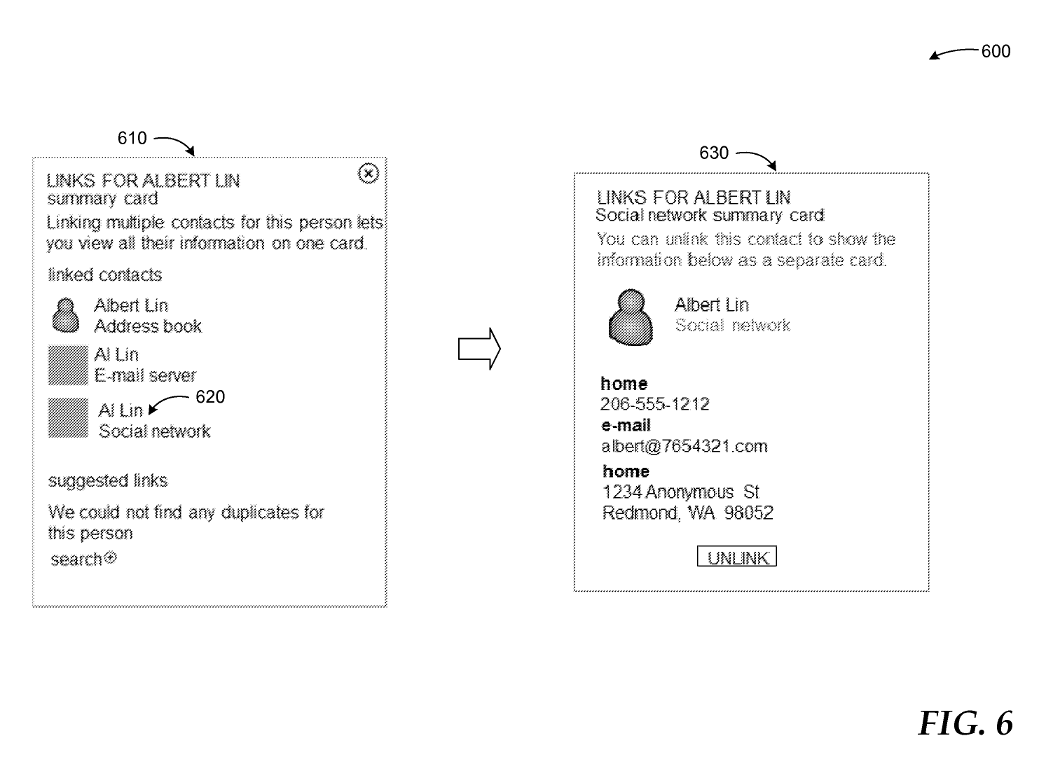

FIG. 6 illustrates an example user interface displaying additional functionality to increase user confidence in the resolution process. Diagram 600 displays a linked contact history function and an unlink function.

In an embodiment, the communication application may store a history of the resolution of the conflicting information through a summary card 610. The history may be displayed upon user demand. The application may store user rejection and ignorance of a suggestion to prevent subsequent suggestion of the contact that includes conflicting information. Alternatively, the application may display the suggestion intermittently according to application settings upon a rejection and a subsequent detection of the contact that includes conflicting information through another external resource. In another embodiment, a list of rejected contacts may be displayed in a summary card similar to the one showing linked contacts. The list of rejected contacts may make it easier for an “undo” function, e.g. the user could use the “summary of rejections” to undo an accidental rejection.

In yet another embodiment, the linking user interface may increase user confidence through functionality to provide a history of the linked contacts through a summary card 610. Additionally, the linking user interface may provide unlink functionality through another summary card 630 to subsequently remove linked contacts. User's visualization of history through a summary card 610 of the linked contacts may remind the user of the resolution to the conflicting contact information. The user may subsequently select to discard linked contacts not matching the existing contact by clicking a linked contact 620 from summary card 610. Unlinking a linked contact from an existing contact may also be streamlined by reminding the user of the linked contact's identifier information. A status card 630 displaying the linked contact's identifier information may inform the user about the reason for the link and enable the user to determine continued appropriateness of the linked contact.

The above discussed linking user interface, example communication application in FIG. 4-6 are for illustration purposes. Embodiments are not restricted to those examples. Other forms of contact conflict resolution may be used in implementing the linking user interface in a similar manner using the principles described herein.

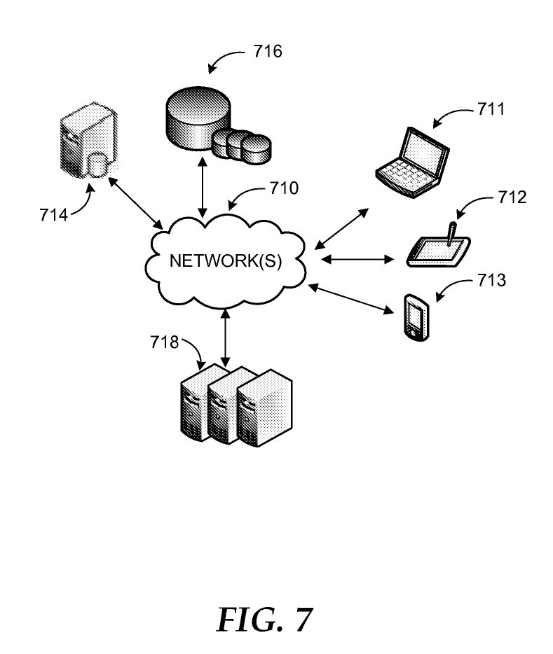

FIG. 7 is an example networked environment, where embodiments may be implemented. A communication application providing communication services including resolving conflicting contact information with existing contacts may be implemented via software executed over one or more servers 718 such as a hosted service. The application may facilitate communications between client applications on individual computing devices such as a smart phone 713, a tablet computer 712, laptop computer 711, and a desktop computer (‘client devices’) through network(s) 710.

As discussed above, a user may store variety of contacts across multiple applications and platforms. Aggregation of the contacts in a single user application may create multiple redundancies and potential conflicts with existing contacts in a communication application. A linking user interface as described above may automate linking of contacts that include conflicting information with suggestions while retaining a high level of user confidence in the linking process through user participation. Similar linking user interface implementation across platforms may also minimize learning efforts for processes related to contact aggregation.

Client devices 711-713 are used to facilitate communications through a variety of modes between users of the communication application. One or more of the servers 718 may be used to manage contact information as discussed above. Contact management information may be stored in one or more data stores (e.g. data store 716), which may be managed by any one of the servers 718 or by database server 714.

Network(s) 710 may comprise any topology of servers, clients, Internet service providers, and communication media. A system according to embodiments may have a static or dynamic topology. Network(s) 710 may include a secure network such as an enterprise network, an unsecure network such as a wireless open network, or the Internet. Network(s) 710 may also coordinate communication over other networks such as PSTN or cellular networks. Network(s) 710 provides communication between the nodes described herein. By way of example, and not limitation, network(s) 710 may include wireless media such as acoustic, RF, infrared and other wireless media.

Many other configurations of computing devices, applications, data sources, and data distribution systems may be employed to resolve conflicting contact information with an existing contact through a suggested link. Furthermore, the networked environments discussed in FIG. 7 are for illustration purposes only. Embodiments are not limited to the example applications, modules, or processes.

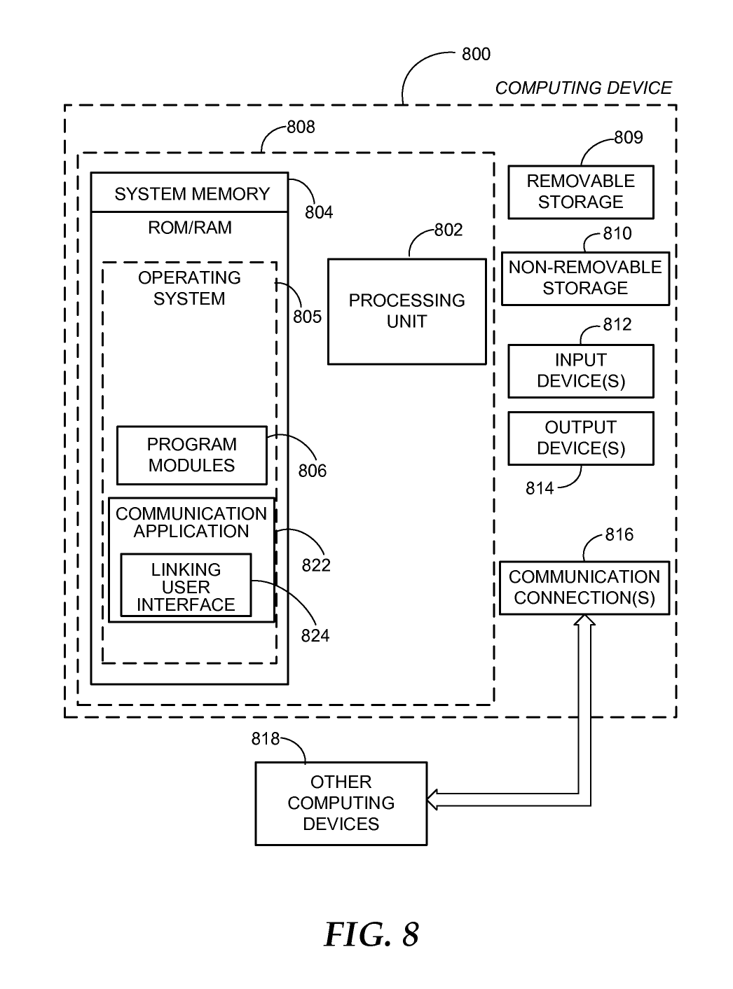

FIG. 8 and the associated discussion are intended to provide a brief, general description of a suitable computing environment in which embodiments may be implemented. With reference to FIG. 8, a block diagram of an example computing operating environment for an application according to embodiments is illustrated, such as computing device 800. In a basic configuration, computing device 800 may be a conflicting information resolution device as part of a communication system and include at least one processing unit 802 and system memory 804. Computing device 800 may also include a plurality of processing units that cooperate in executing programs. Depending on the exact configuration and type of computing device, the system memory 804 may be volatile (such as RAM), non-volatile (such as ROM, flash memory, etc.) or some combination of the two. System memory 804 typically includes an operating system 805 suitable for controlling the operation of the platform, such as the WINDOWS®, operating systems from MICROSOFT CORPORATION of Redmond, Wash. The system memory 804 may also include one or more software applications such as program modules 806, communication application 822, and linking user interface 824.

Communication application 822 may be part of a service that resolves conflicting contact information retrieved from a variety of sources including social networks and e-mail servers. Linking user interface 824 may present suggestions to link contacts that include conflicting information matching an existing contact through common identifier information. This basic configuration is illustrated in FIG. 8 by those components within dashed line 808.

Computing device 800 may have additional features or functionality. For example, the computing device 800 may also include additional data storage devices (removable and/or non-removable) such as, for example, magnetic disks, optical disks, or tape. Such additional storage is illustrated in FIG. 8 by removable storage 809 and non-removable storage 810. Computer readable storage media may include volatile and nonvolatile, removable and non-removable media implemented in any method or technology for storage of information, such as computer readable instructions, data structures, program modules, or other data. System memory 804, removable storage 809 and non-removable storage 810 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 800. Any such computer readable storage media may be part of computing device 800. Computing device 800 may also have input device(s) 812 such as keyboard, mouse, pen, voice input device, touch input device, and comparable input devices. Output device(s) 814 such as a display, speakers, printer, and other types of output devices may also be included. These devices are well known in the art and need not be discussed at length here.

Computing device 800 may also contain communication connections 816 that allow the device to communicate with other devices 818, such as over a wireless network in a distributed computing environment, a satellite link, a cellular link, and comparable mechanisms. Other devices 818 may include computer device(s) that execute communication applications, other directory or policy servers, and comparable devices. Communication connection(s) 816 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

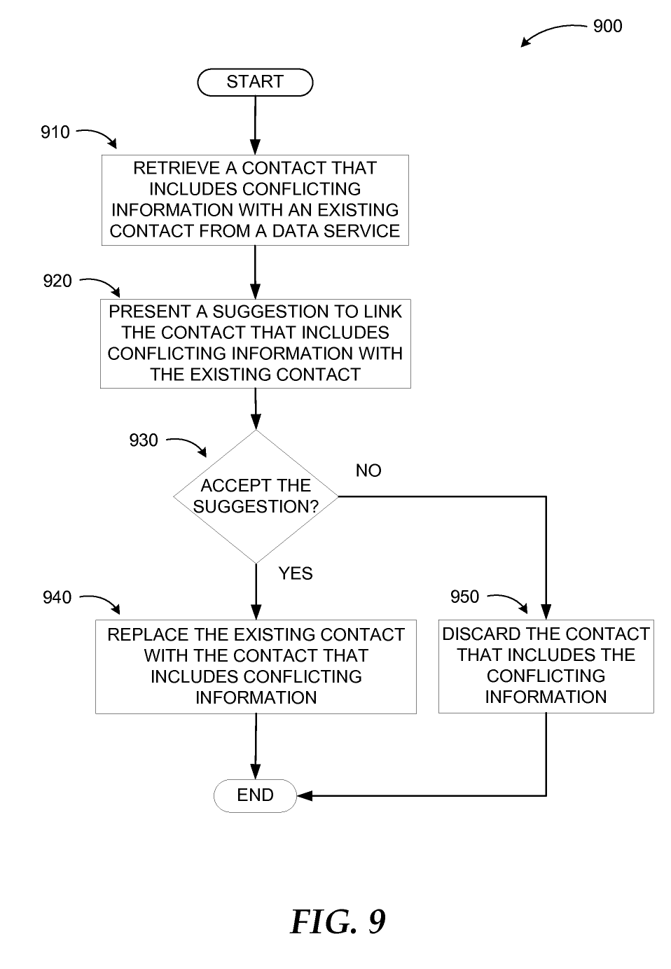

FIG. 9 illustrates a logic flow diagram for a process of resolving contact conflicts through suggested links according to embodiments. Process 900 may be implemented as part of a communication application that resolves conflicting contact information through a linking user interface.

Process 900 begins with operation 910, where a contact that includes conflicting information with an existing contact may be retrieved from a data service. As discussed previously, a data service may access external resources such as social networks, partner applications, e-mail servers, and similar once to retrieve contacts.

At operation 920, a linking user interface of the communication application may present a suggestion to link the contact that includes conflicting information with the existing contact. The suggestion may display information about the contact that includes conflicting information such as the contact's identifier information (e.g.: contact name). Next, the communication application may resolve the conflicting contact information according to a response to the suggestion at decision node 930. Upon an acceptance of the suggestion, the application may augment the existing contact with the contact that includes the conflicting information at operation 940. Upon a rejection of the suggestion, the application may discard the contact that includes conflicting information at operation 950.

The operations included in process 900 are for illustration purposes. A communication application configured to resolve conflicting contact information according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method to be executed at least in part in a computing device for resolving conflicting contact information through a suggested link, the method comprising:
retrieving a contact that includes conflicting information with an existing contact from a data service;
presenting at least one suggestion to link the contact that includes the conflicting information with the existing contact; and
resolving the conflicting information based on a response to the suggestion from a user including one of:
augmenting the existing contact with the conflicting information upon an acceptance of the suggestion, and
discarding the contact that includes the conflicting information upon a rejection of the suggestion.

2. The method of claim 1, further comprising:
employing a sliding scale based algorithm to recognize the contact that includes the conflicting information.

3. The method of claim 2, further comprising:
assigning a confidence score based on a degree of match of a predetermined number of identifiers between the contact that includes the conflicting information and the existing contact.

4. The method of claim 2, further comprising:
assigning a confidence score according to a source for the contact that includes the conflicting information.

5. The method of claim 4, further comprising:
increasing the confidence score if the source is a local source; and
decreasing the confidence score if the source is an external source.

6. The method of claim 2, further comprising:
displaying a list of rejected contacts to enable the user to undo accidental rejections.

7. The method of claim 2, further comprising:
adjusting the sliding scale according to a level of interaction between the user and the existing contact.

8. The method of claim 1, further comprising:
maintaining a history of the resolution of the conflicting information.

9. The method of claim 8, further comprising:
storing at least one of the acceptance, the rejection, and an ignorance of the suggestion; and
preventing subsequent suggestion of the contact that includes the conflicting information upon at least one of the rejection and the ignorance of the suggestion by the user.

10. The method of claim 8, further comprising:
displaying the contact that includes the conflicting information intermittently according to an application setting upon the rejection of the contact that includes the conflicting information and a subsequent detection of the contact that includes the conflicting information from a different data service.

11. The method of claim 1, further comprising:
unlinking the contact that includes the conflicting information from the existing contact upon a subsequent user action to discard a previously linked contact.

12. A communication system for resolving conflicting contact information through a suggested link, the system comprising:
a memory;
a processor coupled to the memory, the processor executing a communication application, wherein the communication application is configured to:
retrieve a contact that includes conflicting information with an existing contact from a data service;
employ a sliding scale based algorithm to recognize the contact that includes the conflicting information;
present a suggestion to link the contact that includes the conflicting information with the existing contact through a linking user interface; and
resolve the conflicting information based on a response to the suggestion from a user including one of:
augment the existing contact with the contact that includes the conflicting information upon an acceptance of the suggestion, and
discard the contact that includes the conflicting information upon a rejection of the suggestion.

13. The system of claim 12, wherein the communication application is further configured to:
display a summary card that includes summary contact information and the suggestion;
during resolution of the conflicting information, display additional contact information; and
upon completion of the resolution, revert to the summary card with the suggestion discarded.

14. The system of claim 12, wherein the communication application is further configured to display, through the linking user interface:
a count of suggestion links; and
the contact that includes the conflicting information in an appearing-and-disappearing manner.

15. The system of claim 12, wherein the communication application is further configured to:
limit a number of displayed suggestions to simplify resolving the conflicting information.

16. The system of claim 12, wherein communication application is further configured to:
provide hints to remind the user about the suggestion in response to at least one from a set of: the user receiving a communication from the contact that includes the conflicting information, the user sending a communication to the contact that includes the conflicting information, the user performing a search, and the user editing contact information for the contact that includes the conflicting information.

17. The system of claim 12, wherein the linking user interface displays the suggestion in-line with other suggestions to streamline a user action to resolve the conflicting information.

18. A computer-readable memory device with instructions stored thereon for resolving conflicting contact information through a suggested link, the instructions containing:
retrieving a contact that includes conflicting information with an existing contact from a data service;
employing a sliding scale based algorithm to recognize the contact that includes the conflicting information;
presenting at least one suggestion to link the contact that includes the conflicting information with the existing contact through a linking user interface;
resolving conflicting information based on a response to the suggestion from a user including one of:
augmenting the existing contact with contact the that includes conflicting information upon an acceptance of the suggestion, and
discarding the contact that includes the conflicting information upon a rejection of the suggestion and;
maintaining a history of the resolution of the conflicting information.

19. The computer-readable memory device of claim 18, wherein the instructions further comprise:
adjusting the linking user interface to multiple platforms including one of a desktop device based platform and a mobile device based platform by displaying the at least one suggestion in a scalable summary card.

20. The computer-readable memory device of claim 18, wherein the instructions further comprise:
comparing the contact that includes the conflicting information with the existing contact for one of a partial match and a complete match of at least one from a set of: a name, an e-mail address, a phone number, an instant messaging address, and a birthdate.
